(19) United States
(12) Patent Application Publication
(10) Pub. No.: US 2008/0196416 A1
(43) Pub. Date: Aug. 21, 2008

(54) Method and system for liquid cryogen injection in mixing or blending devices

(76) Inventors: John Martin Girard, Downers Grove, IL (US); David Joseph King, Frankfort, IL (US); Theodore Hall Gasteyer, Naperville, IL (US); Yeu-Chuan Simon Ho, Naperville, IL (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/707,538

(22) Filed: Feb. 16, 2007

(51) Int. Cl. F17C 6/00

(52) U.S. Cl. 62/46.1; 62/65

(57) ABSTRACT

A liquid cryogen based blending system and method is provided. The disclosed embodiment of the system includes a liquid cryogen flow circuit, a heated fluid circuit, and a plurality of injectors or nozzles disposed adapted for injection of a liquid cryogen into or near a product to be cooled. The disclosed system and method also includes a controller adapted to operatively control the injection of liquid cryogen and concurrently control the flow warm fluid, such as nitrogen vapor, to and thru the plurality of injectors.

### CROSS REFERENCE TO RELATED APPLICATIONS

None

### FIELD OF THE INVENTION

The present invention relates to an apparatus and system for cooling a product or material in a blending or mixing device, and more particularly to a system and method for injecting a liquid cryogen within a blender or mixer device.

### BACKGROUND

The use of liquid nitrogen as a cooling medium in a blender or mixer apparatus, while not new, presents numerous challenges to be accepted as a commercially viable technique. One such challenge comes from the realization that liquid nitrogen needs to be injected or deposited close to or into the product being cooled in order to maximize heat transfer. As a result of this injection requirement, prior art liquid nitrogen injections systems suffer from two key problems, namely nozzle malfunction as a result of the nozzle or injector body becoming too cold or local over-freezing of the product near locations of liquid nitrogen injection. Various injection configurations and arrangements previously considered have attempted to address this concern with limited success.

What is needed, therefore, is a simple and efficient means to cool product within a blending or mixing device with a liquid cryogen, such as liquid nitrogen, that minimizes adverse effects and addresses the disadvantages of the prior art systems.

### SUMMARY OF THE INVENTION

The present invention may be characterized as a liquid cryogen based blending or mixing system. The system comprises: a housing defining a cooling chamber; a plurality of injectors disposed within the cooling chamber and adapted for injection of a liquid cryogen into the cooling chamber; a liquid cryogen flow circuit adapted to couple a source of liquid cryogen to the plurality of injectors for injection into the cooling chamber; a gas flow circuit adapted to couple a source of gas with the plurality of injectors; and a controller adapted to operatively control the injection of liquid cryogen from the plurality of injectors into the cooling chamber and concurrently control the flow of gas to the plurality of injectors to maintain the plurality of injectors at a prescribed temperature range.

In another aspect, the present invention may be characterized as a liquid cryogen nozzle for a blending or mixing system comprising: a nozzle body defining a flow path connecting a first opening at a proximate end of the nozzle body for receiving a liquid cryogen and a second opening at a distal end of the nozzle body for delivering the liquid cryogen to the blending system; an insulating sleeve disposed around the nozzle body defining an outer surface of the nozzle, the insulating sleeve adapted for circulating a warm fluid therethrough to maintain the outer surface of the nozzle at a prescribed temperature range.

Finally, the invention may be characterized as a method of introducing liquid cryogen into a blending system comprising the steps of: injecting a liquid cryogen via a plurality of nozzles into a cooling chamber; and concurrently circulating a gas around the nozzles to maintain the nozzles within a prescribed temperature range.

### BRIEF DESCRIPTION OF THE DRAWINGS

The above and other aspects, features, and advantages of the present invention will be more apparent from the following, more detailed description thereof, presented in conjunction with the following drawings, wherein:

FIG. 1 is a partial cut-away representation of a blending or mixing apparatus incorporating the present invention;

FIG. 2 is a cross-sectional representation of an embodiment of the preferred nozzle in accordance with the present invention; and

FIG. 3 is a schematic representation of the liquid cryogen and gas flow circuits associated with the preferred embodiment of the present invention.

Corresponding numerals used in the various figures are intended to describe the same or similar components.

### DETAILED DESCRIPTION

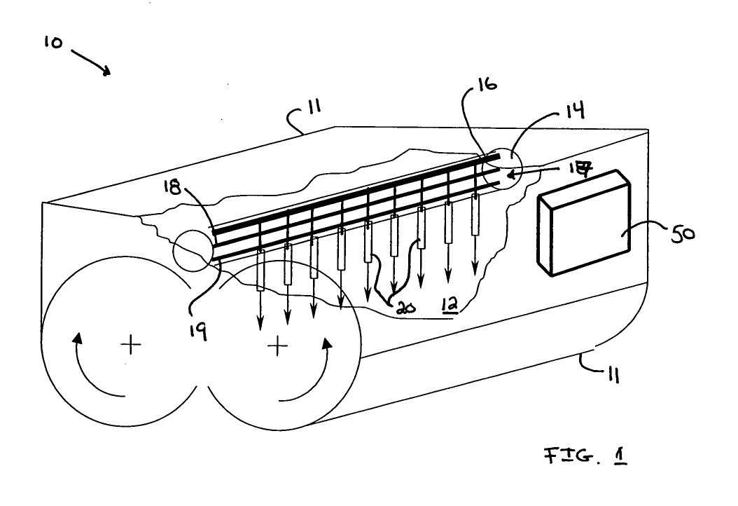

Referring now to FIG. 1, there is shown a representation of a blending or mixing system 10 incorporating the present invention. As seen therein, blending system 10 includes a mixer or blender housing 11 defining a cooling chamber 12 that is adapted to mix or blend various products. The system 10 further includes a refrigerant manifold 14 having portions of a liquid cryogen circuit 16 and a warm fluid circuit 17 disposed therein. Extending from the manifold 14 into the cooling chamber 12 is a plurality of cryogen injector nozzles 20. The system 10 further includes a control system 50 operatively controlling the flow of a liquid cryogen through the liquid cryogen circuit 16 and the flow of a warm fluid through the warm fluid circuit 17 as well as the periodic injection of the liquid cryogen and warm fluid via the nozzles 20 into the cooling chamber 12. In the illustrated embodiment, the warm fluid circuit 17 includes a warm fluid supply circuit 18 and a warm fluid return circuit 19.

When liquid nitrogen is used as the cooling medium, the liquid nitrogen needs to be injected or deposited close to the product being cooled to maximize cold transfer. Thus, in the illustrated embodiment, the nozzles 20 extend from the manifold 14 into the chamber 12 to a location proximate or below the level or anticipated level of the product in the chamber 12. The preferred placement of the nozzles 20 is to a position where the nozzle tip is below the product level in the mixing chamber 12 of a blender system 10. Such an arrangement allows the liquid cryogen injected from the nozzle 20 to lance through the product and circulate or move within the product in the mixing chamber as long as possible, thereby maximizing the cold transfer.

In a mixer or blending system 10 containing two axles as depicted in FIG. 1, the manifold 14 containing the liquid cryogen is centrally disposed such that liquid cryogen is injected into the product as the product within the cooling chamber 12 rotates toward the center of the mixer housing 11. Also, the nozzles 20 extend downward from the manifold 14 such that the product flows around the nozzle tips. For safety and sanitation purposes, the manifold 14 as well as all transfer lines and other portions of the liquid cryogen circuit 16 and warm fluid circuit 17 remain above the level of the product.

Although not shown, the nozzles and associated components in a single axis mixer would preferably be located such that the injected liquid cryogen would travel with the product on the downward motion of the rotational movement. Alternatively, the nozzle placements may also include locations on the sides or bottom of the housing. Such side and bottom nozzle placements may require alternate flow control schemes, particularly for the warm fluid circuit, so as to keep the nozzles functioning properly.

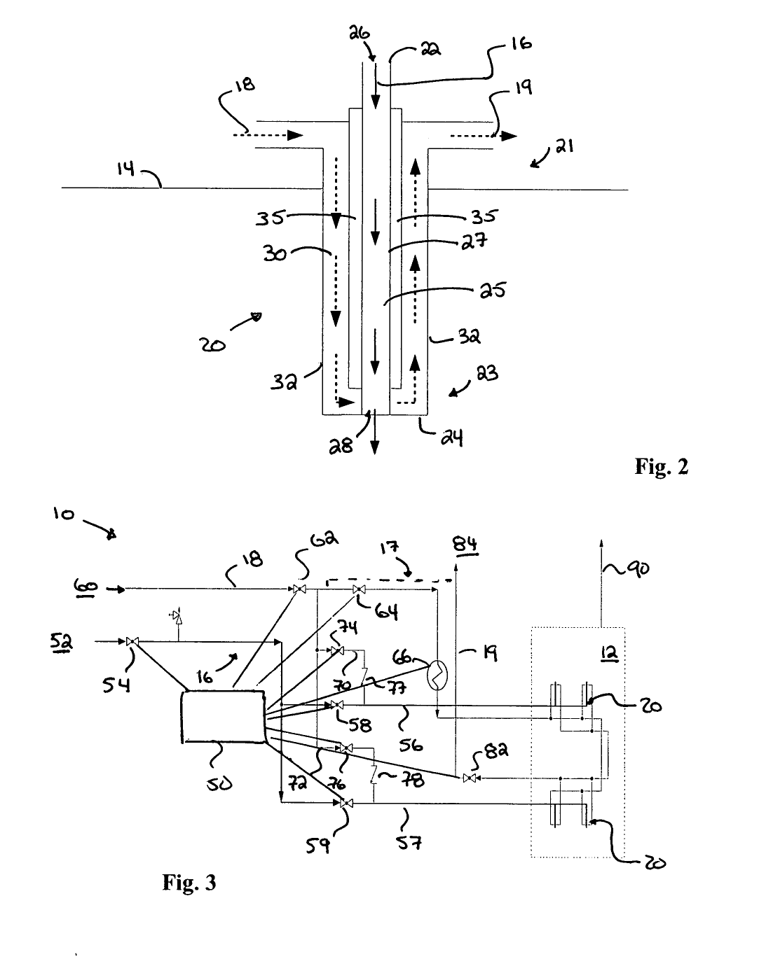

Turning now to FIG. 2, there is shown a representation of a nozzle 20 adapted for use in the presently disclosed system. The illustrated nozzle 20 includes an upper portion 21 having a proximate end 22 and a lower portion 23 defining a distal end 24. The upper portion 21 of the nozzle 20 is disposed within or affixed to the refrigeration manifold 14. The lower portion 23 extends into the mixing or blending chamber where the distal end 24 of the nozzle 20 is disposed proximate to or comes into contact with the product to be frozen.

As seen in FIG. 2, the nozzle 20 includes an inner or centrally disposed tube 25 adapted to receive liquid cryogen from a source of liquid cryogen (not shown) via a manifold 14 and deliver liquid cryogen to an injection point within the mixing or blending chamber. The inner or centrally disposed tube 25 includes a first opening 26 at the proximate end 22 of the nozzle 20 for receiving a liquid cryogen from the liquid cryogen circuit 16, a body portion 27, and a second opening 28 at the distal end 24 of the nozzle 20 for delivering the liquid cryogen to the blending chamber.

As will be discussed in more detail below, the centrally disposed tube 25 may also be fluidically coupled to the warm fluid circuit to provide a controlled pre-injection or post injection purging of the inner or centrally disposed tube 25 with the warm fluid, preferably a gas such as nitrogen vapor.

The nozzle 20 further includes an outer sleeve 30 concentrically disposed around the inner or centrally disposed liquid cryogen tube 25. In the depicted embodiment, the outer sleeve 30 also defines an outer surface 32 of the nozzle 20. The outer sleeve 30 is adapted for circulating a warm fluid, preferably a heated gas such as a heated nitrogen vapor, therethrough to maintain the outer surface 32 of the nozzle and the nozzle tip or distal end 24 within prescribed temperature ranges. Preferably, the prescribed temperature of the outer surface 32 is such that the product to be frozen does not freeze onto the outer surface 32 or distal end 24 of the nozzle 20.

Interposed between the inner or centrally disposed tube 25 and the outer sleeve 30 is a sealed annular space 35 which operates to insulate the liquid cryogen flowing within the body portion 27 of the inner or central tube 25 from the warm fluid flowing through the outer sleeve 30. In the illustrated embodiment, the sealed annular space 35 is concentrically disposed around the body portion 27 of the inner tube 25 and does not extend to the tip or distal end 24 of the nozzle 20. Rather there is a direct interface between the outer sleeve 30 and the inner tube 25 proximate the tip or distal end 24 of the nozzle 20. Generally, the sealed annular space 35 between the body portion 27 of the inner tube 25 and outer sleeve 30 serves as a thermal break which minimizes the cold transfer from the liquid cryogen flowing within the inner tube 25 and the outer surface 32 of the nozzle 20. The sealed annular space 35 can be filled with a gas, insulation material, or can even incorporate a vacuum.

Turning now to FIG. 3, there is shown a general flow schematic associated with an embodiment of the system 10. The system 10 includes a plurality of nozzles 20 each of which is in flow communication with both the liquid cryogenic circuit 16 and the warm fluid circuit 17.

In the illustrated schematic the liquid cryogenic circuit 16 includes a source of liquid cryogen 52 and a main control valve 54 disposed between the source of liquid cryogen 52 and the blender or mixer apparatus. The main control valve 54 is operatively coupled to the control system 50 to shut off the flow of liquid cryogen when the system 10 is shut down either automatically, in emergency situations, or when other prescribed safety-related or operational situations are presented. The liquid cryogen circuit 16 also includes a plurality of liquid cryogen conduits 56,57 each associated with one or more nozzles 20 and disposed downstream of the main control valve 54.

In the illustrated embodiment, there are two liquid cryogenic conduits 56,57 each coupled to a pair of illustrated nozzles 20. The liquid cryogenic circuit 16 also includes injection control valves 58,59 each of which is disposed in operative association with each liquid cryogenic conduit 56,57. Each injection control valve 58,59 is operatively controlled by the control system 50 in response to user settings, user commands, and related system operating parameters.

As indicated above, the warm fluid circuit 17 includes a warm fluid supply circuit 18 and a warm fluid return circuit 19. The warm fluid supply circuit 18 further comprises a supply of the fluid 60, in this case nitrogen gas, and a main shutoff valve 62. The main shutoff valve 62 is operatively coupled to the control system 50 to shut off the flow of nitrogen gas or other fluid when the system 10 is shut down either automatically, in emergency situations, or when other prescribed safety-related or operational situations are presented. A gas control valve 64 and a fluid heater element 66 are also preferably disposed in the warm fluid supply circuit 18 to control the flow and temperature of the warm fluid to the outer sleeve of each nozzle 20. The gas control valve 64 and the heater element 66 are also operatively controlled by the control system in response to system commands and operating parameters.

The warm fluid supply circuit 18 also includes one or more warm fluid injection circuits 70,72 diverting the nitrogen gas from the warm fluid supply circuit 18 to the liquid cryogen circuit 16. Within each warm fluid injection circuit 70,72 there is a warm fluid injection control valve 74,76 and a one way check valve 77,78 which prevents the liquid cryogen from flowing back into the warm fluid supply circuit 17. Like the other control valves, the warm fluid injection control valves 74,76 are operatively controlled by control system 50 to initiate a pre-injection and/or post injection of a select volume of the gas at the appropriate timing sequence via the nozzle 20. The number of warm fluid injection circuits will generally match the number of liquid cryogen conduits such that each liquid cryogen conduit 56,57 is coupled to a warm fluid injection circuit 70,72 allowing the line and nozzles 20 to be purged with the nitrogen gas before and/or after injection of the liquid cryogen.

The warm fluid return circuit 19 includes a relief valve 82 and a vent 84 that allows the warm fluid to be vented outside the processing environment or used for other facility purposes. An alternative embodiment, and in some applications the preferred embodiment, is to have the warm fluid circuit 17 form a closed loop circuit. Using the closed circuit approach, the fluid in the warm fluid return conduit 19 is circulated back to the warm fluid supply circuit 18 using a pump (not shown) or similar recirculating means.

In many commercial applications, the blender or mixer has an exhaust system 90 to remove any vapor generated as a result of liquid cryogen injection into the product within the mixer. Typically, the exhausted vapors may contain the capacity to remove additional heat. Therefore, it is contemplated to recycle the exhausted vapors to other plant or facility refrigeration requirements including any post-mixing equipment downstream of the blending system 10.

As may be appreciated from consideration of FIG. 3 and the associated description, there are multiple functions or purposes associated with the warm fluid circuit 17. First, when the warm fluid (e.g. nitrogen gas) flow is diverted to the warm fluid injection circuits 70,72, through either control valve 74 or control valve 76, the nitrogen gas provides purging or gassing to the liquid cryogen conduit 56,57 and the associated nozzles 20. The purging is preferably done in advance of the liquid cryogen injection (i.e. pre-injection step) or subsequent to the liquid cryogen injection (i.e. post-injection step) or both. The pre-injection step is useful in clearing or removing any product that might be attached to the nozzle tip associated with the particular liquid cryogen conduit 56,57. The post-injection step is preferably used to clear the liquid cryogen conduit 56,57 and associated nozzle 20 of any remaining cryogenic liquid. This, in turn, prevents the nozzle tip from over-cooling and impedes any cold transmission from in the inner tube of the nozzle to the outer sleeve and outer surface of the nozzle.

In addition, the warm fluid circuit 17 provides the warm fluid that circulates through the outer sleeve of the nozzle 20 to prevent product from freezing or latching to the nozzle as well as preventing the nozzle body from getting overly cold.

Independent control of the injection control valves 58,59 is the preferred mode of operating the presently disclosed system 10. In the independent control scheme, the liquid cryogen (e.g. liquid nitrogen) injection is controlled by means of the control system 50 to cause intermittent flow of the liquid cryogen through the injection control valves 58,59 throughout the entire product treatment cycle. The injection cycles for each of the nozzles are also staged such that liquid cryogen is mostly being delivered via one or more nozzles 20 into the chamber 12 but not all nozzles are concurrently injecting the liquid cryogen.

As indicated above, injection of liquid cryogen thru each nozzle is intermittently cycled on and off so as to avoid continuously injecting liquid cryogen during the entire product treatment cycle. Constant liquid injection from a single nozzle can lead to localized over-freezing of the product as well as damage or degradation in performance of the nozzle in the form of longer recovery and relaxation times for the nozzle.

The on and off cycle times for liquid cryogen injection through a nozzle or a plurality of nozzles can be periodic or aperiodic. The preferred duration of each on or off cycle as well as other injection parameters are set by the user or otherwise programmed into the control system 50.

Preferably, while the liquid cryogen is intermittently injected via the nozzles, the warm fluid flows through the warm fluid supply circuit to the outer sleeve of the nozzle during the entire cycle to maintain each nozzles within a prescribed temperature range. Also, the pre-injection and post-injection of warm fluid (e.g. nitrogen gas) through each nozzle is precisely controlled to occur during the appropriate off-cycle times for each nozzle.

As can be appreciated from the foregoing description, the presently disclosed system provides a liquid cryogen based blending system and method incorporating an improved nozzle design and associated injection control techniques. In a broad sense the system includes a liquid cryogen flow circuit, a heated gas flow circuit, and a plurality of injectors or nozzles disposed adapted for efficient injection of a liquid cryogen into or near a product to be cooled. The disclosed system and method also includes a controller adapted to operatively control the injection of liquid cryogen and concurrently control the flow of heated gas to and thru the plurality of injectors.

The present system, while specifically designed for food processing applications is equally applicable to other refrigeration and mixing applications including chemical, biopharmaceutical, and pharmaceutical materials and products. In addition, the above-identified systems methods and the features associated therewith can be utilized alone or in conjunction with other food treatment processes and variations. Moreover, each of the specific steps involved in the disclosed methods, described herein, and each of the inputs, elements, or variables in the preferred injection system are easily modified or tailored to meet the specific product requirements which it is used or other operating environment and safety restrictions.

From the foregoing, it should be appreciated that the present invention thus provides a system and method for injecting a liquid cryogen into a mixing and blending system. While the invention herein disclosed has been described by means of specific embodiments and processes associated therewith, numerous modifications and variations can be made thereto by those skilled in the art without departing from the scope of the invention as set forth in the claims or sacrificing all its material advantages.

What is claimed is:

1. A liquid cryogen blending system comprising:
a housing defining a cooling chamber;
a plurality of injectors disposed within the cooling chamber and adapted for injection of a liquid cryogen into the cooling chamber;
a liquid cryogen flow circuit adapted to fluidically couple a source of liquid cryogen to the plurality of injectors for injection into the cooling chamber;
a warm fluid circuit adapted to fluidically couple a source of warm fluid with the plurality of injectors; and
a controller adapted to operatively control the injection of liquid cryogen from the plurality of injectors into the cooling chamber and concurrently control the flow of warm fluid to the plurality of injectors to maintain the plurality of injectors at a prescribed temperature range.

2. The system of claim 1 further comprising a heater disposed within the warm fluid flow circuit for further heating of the warm fluid.

3. The system of claim 1 wherein the controller is further adapted to operatively control the injection of liquid cryogen for each injector in an intermittent pattern.

4. The system of claim 1 wherein the controller is further adapted to operatively control the injection of liquid cryogen for the plurality of injectors in a staggered pattern.

5. The system of claim 1 wherein the controller is further adapted to operatively control the injection of the warm fluid through each of the plurality of injectors to the cooling chamber to prevent the plugging of the injectors.

6. The system of claim 5 wherein the injection of the warm fluid through each of the injectors follows the injection of liquid cryogen.

7. The system of claim 5 wherein the injection of the warm fluid through each of the injectors precedes the injection of liquid cryogen.

8. The system of claim 1 wherein the liquid cryogen is liquid nitrogen.

9. The system of claim 2 wherein the warm fluid is nitrogen vapor.

10. A liquid cryogen nozzle for a blending system comprising:
a nozzle body defining a flow path fluidically connecting a first opening at a proximate end of the nozzle body for receiving a liquid cryogen and a second opening at a distal end of the nozzle body for delivering the liquid cryogen to the blending system;
an outer sleeve disposed around the nozzle body defining an outer surface of the nozzle, the outer sleeve adapted for circulating a warm fluid therethrough to maintain the outer surface of the nozzle at a prescribed temperature range.

11. The nozzle of claim 10 wherein the outer sleeve further defines an annular space between the liquid cryogen tube and the outer sleeve.

12. The nozzle of claim 10 wherein the outer sleeve is further disposed in direct contact to the tube proximate the distal end.

13. The nozzle of claim 10 further comprising an intermediate spacer disposed between the nozzle body and the outer sleeve to define a sealed annular space between the nozzle body and the outer sleeve.

14. A method of introducing liquid cryogen into a blending system comprising the steps of:
injecting a liquid cryogen via a plurality of nozzles into a cooling chamber of the blending system;
concurrently circulating a warm fluid around the nozzles to maintain the nozzles within a prescribed temperature range.

15. The method of claim 14 further comprising the step of heating the warm fluid prior or during the circulation step.

16. The method of claim 14 wherein the injection of liquid cryogen in one or more nozzles is intermittent.

17. The method of claim 14 wherein the injection of liquid cryogen thru the plurality of nozzles is staggered.

18. The method of claim 16 further comprising the step of injection of the warm fluid through one or more nozzles to the cooling chamber after the injection of liquid cryogen.

19. The method of claim 16 further comprising the step of injection of the warm fluid through one or more nozzles to the cooling chamber before the injection of liquid cryogen.

20. The method of claim 14 wherein the step of injection of the warm fluid through one or more nozzles further comprises direct injection of liquid cryogen from above a top surface of a product into the product.
